(19) United States
(12) Patent Application Publication
(10) Pub. No.: US 2025/0146749 A1
(43) Pub. Date: May 8, 2025

(54) DRYING APPARATUS AND METHOD FOR DRYING CONTAINERS HAVING AT LEAST ONE CONTAINER PROPERTY

(71) Applicant: BELVAC PRODUCTION MACHINERY, INC., Lynchburg, VA (US)

(72) Inventors: Ulf REINHARDT, Teutschenthal (DE); Wilko HARMS, Wittmund (DE)

(21) Appl. No.: 18/684,257

(22) PCT Filed: Aug. 5, 2022
(86) PCT No.: PCT/DE2022/100568

§ 371 Date: Feb. 16, 2024

(30) Foreign Application Priority Data
Aug. 19, 2021 (DE) 10 2021 121 585.4

(51) Int. Cl. F26B 15/18; F26B 21/12

(52) U.S. Cl. CPC F26B 15/18; F26B 21/12

(57) ABSTRACT

The invention relates to a drying apparatus for drying containers having at least one container property, the drying apparatus including a cooling portion in which the containers can be cooled, a fluid flow device that is arranged and designed to apply a fluid flow to the containers within the cooling portion, and a control device that is designed to control the fluid flow device according to the at least one container property in such a way that the containers are cooled by the fluid flow.

### CROSS-REFERENCE TO RELATED APPLICATIONS

This application is a U.S. national stage of International Application No. PCT/DE2022/100568, filed Aug. 5, 2022, which claims the benefit of and priority to German Patent Application No. 10 2021 121 585.4, filed Aug. 19, 2021, each of which are hereby incorporated by reference herein in its entirety.

### FIELD

The invention relates to a drying apparatus and a method for drying containers.

### BACKGROUND

Drying apparatuses are generally known. Drying apparatuses are provided, for example, as a continuous oven with a conveyor belt, wherein the containers, which are designed as cans, are moved through an oven by means of the conveyor belt and are exposed to hot air during this process. Furthermore, drying apparatuses can have chains with pins for conveying the cans. Such drying apparatuses are also known as pin ovens.

Typically, such an oven has several drying chambers arranged one behind the other, in which water evaporates, the cans are heated to a target temperature and remain at the target temperature for a predefined period of time in order to remove water from the cans and also to ensure polymerization of a coating, in particular a lacquer.

Such a drying apparatus is also referred to as a paint drying oven, which is designed in particular to dry and/or polymerize an interior coating and/or an exterior coating of a can. Furthermore, such a drying apparatus can be a continuous dryer for drying the cans after a cleaning process. After the cans have passed through the drying chambers, they have a high temperature. This high temperature increases the temperature in the area surrounding the drying apparatus. In addition, the high temperature of the cans can have negative effects in a downstream manufacturing process. To reduce the temperature of the cans, a cooling portion is often provided downstream of the drying chambers.

In the cooling portion, the cans are exposed to a fluid in such a way that the temperature of the cans is reduced. To ensure reliable cooling, the fans are set to a predefined value to provide the fluid flow. This value is set independently of the actual cooling capacity to be provided and, in particular, is set on the basis of the maximum can volume to be cooled.

Cooling the cans requires a great deal of energy. As a rule, the fluid flow provided in the cooling portion is oversized to ensure reliable cooling. The difference between the fluid flow actually required and the set fluid flow represents a waste of energy.

It is an industry requirement that such drying apparatuses have the lowest possible energy consumption. Due to the increasing requirements with regard to ecological boundary conditions in particular, the aim is to make such drying apparatuses more energy-efficient. This also improves the ecological footprint of each can, so that considering an annual can volume of several hundred billion cans that are produced on more than 600 lines worldwide with a capacity of more than one billion cans per year, a major impact on the ecological footprint is possible.

### SUMMARY

According to one embodiment, a drying apparatus for drying containers having at least one container property is disclosed. The apparatus comprises a cooling portion in which the container can be cooled. The apparatus further comprises a fluid flow device arranged and designed to apply a fluid flow to the container within the cooling portion. The apparatus further comprises a control device designed to control the fluid flow device according to the at least one container property in such a way that the container is cooled with the fluid flow.

According to another embodiment, a method of drying containers having at least one container property is disclosed. The method comprises determining a container property of the container, pressurizing the container with a fluid flow, and adjusting the fluid flow according to the container properties for cooling the container.

### BRIEF DESCRIPTION OF THE DRAWINGS

Preferred exemplary embodiments are explained by way of example with reference to the enclosed figures. It shows:

FIG. 1: a schematic, two-dimensional view of an exemplary embodiment of a drying apparatus;

FIG. 2: a schematic, two-dimensional view of a further exemplary embodiment of a drying apparatus; and

FIG. 3: a schematic view of a method.

In the figures, identical or essentially functionally identical or similar elements are designated with the same reference symbols.

### DETAILED DESCRIPTION

It is therefore a task of the invention to provide a drying apparatus and a method for drying containers which reduce or eliminate one or more of the disadvantages mentioned. In particular, it is a task of the invention to provide a solution that enables a more energy-efficient production of containers, in particular cans.

This problem is solved with a drying apparatus and a method according to the features of the independent patent claims. Further advantageous embodiments of these aspects are indicated in the respective dependent patent claims. The features listed individually in the patent claims and the description can be combined with one another in any technologically meaningful way, wherein further embodiments of the invention are shown.

According to a first aspect, the problem is solved by a drying apparatus for drying containers with at least one container property, comprising a cooling portion in which the containers can be cooled, a fluid flow device which is arranged and designed to act on the containers with a fluid flow within the cooling portion, and a control device which is designed to control the fluid flow device according to the at least one container property in such a way that the containers are cooled with the fluid flow.

Among other things, the invention is based on the realization that the fluid flow for cooling the containers can be adjusted according to a container property in such a way that it enables efficient cooling of the containers. In particular, the dependence on the at least one container property prevents the fluid flow from being set too high. The containers can thus be cooled precisely by a specifically adjusted fluid flow. This also prevents the set fluid flow from being set significantly higher than the fluid flow actually required to cool the containers.

In particular, the drying apparatus can be a paint drying oven. For example, the drying apparatus can be designed to dry a coating on the containers, such as a lacquer. Furthermore, this coating can be arranged on the inside or outside of the containers.

The containers can be used for storing drinks and/or food, for example. In particular, the containers can be cans, for example beverage cans. The containers can be made or consist of steel and/or aluminum.

In particular, the cooling portion can be a three-dimensional space. The cooling portion can, for example, be an essentially enclosed space. It is also preferable that the cooling portion is arranged downstream of drying chambers in the direction of container movement to heat up the containers.

The fluid flow device is arranged and designed to pressurize the containers with the fluid flow within the cooling portion. The fluid flow device is designed in particular to provide the fluid flow. The fluid flow device can, for example, have one, two, or more fans with which air from the environment of the drying apparatus is conveyed into the cooling portion. In particular, the fluid flow device is arranged and designed in such a way that the fluid flow can be directed towards the containers. Pressurizing the containers with the fluid flow means, for example, that a cavity of the containers, concave container portions, for example a base, and/or a lateral surface of the containers is or are pressurized with the fluid flow.

The control device is designed to control the fluid flow device according to the at least one container property in such a way that the containers are cooled with the fluid flow. In particular, this means that the fluid flow provided by the fluid flow device is adjusted according to the container properties. For example, a functional relationship between a container temperature and the quantity per time or the fluid pressure of the fluid flow can be taken into account. In other words, the higher the temperature of the containers, the higher the required quantity per time of the fluid flow, for example, to enable a defined cooling of the containers.

It is particularly preferred that the containers are cooled with the fluid flow to or below a predefined temperature. The predefined temperature is preferably less than or equal to 120° C., less than or equal to 110° C., less than or equal to 100° C., less than or equal to 95° C., less than or equal to 90° C., less than or equal to 75° C., in particular less than or equal to 50° C. and/or less than or equal to 25° C.

The container property of the containers can be a kinetic, a material-specific, and/or geometric container property. As explained in more detail below, the container property can be a conveying velocity, a container temperature, a heat capacity, an air temperature at a predefined distance from the containers, a transport density, and/or a container geometry.

A preferred embodiment of the drying apparatus comprises a conveyor unit with which the containers can be moved through the cooling portion at a conveying velocity, wherein the at least one container property is the conveying velocity. The containers can be moved through the cooling portion in a horizontal direction, for example, in particular with a conveyor belt, and/or in a meandering manner, for example with a pin chain.

Taking the conveying velocity into account when controlling the fluid flow device is advantageous, as there is a functional relationship between the dwell time in which the containers are located within the cooling portion and the cooling effect at a defined fluid flow. The higherthe conveying velocity through the cooling portion is set, the shorter the dwell time in the cooling portion and the greater the fluid flow to be set. Since the conveying velocity is usually also dependent on the required conveying velocity of the containers through the drying chambers upstream in the container conveying direction, it is usually advantageous to adjust the fluid flow device and essentially not the conveying velocity. A further preferred embodiment of the drying apparatus is characterized by the fact that the conveyor unit is or comprises a chain, in particular a pin chain, or a conveyor belt. With a chain, in particular a pin chain, the containers can be advantageously conveyed through the cooling portion in a meandering manner.

A further preferred embodiment of the drying apparatus comprises a velocity sensor coupled to the control device by means of signal technology to detect the conveying velocity. It is particularly preferred that the velocity sensor is arranged within the cooling portion. Although the conveying velocity is a setting variable of the drying apparatus, it is advantageous to detect the conveying velocity with a velocity sensor in order to enable redundant and therefore reliable detection of the conveying velocity. It is particularly preferred that the velocity sensor is arranged at a container inlet of the cooling portion.

A further preferred embodiment is further characterized in that the at least one container property is a container temperature and/or a heat capacity of the containers. The container temperature is in particular the temperature of the containers at which the containers enter the cooling portion. A high container temperature leads to an increased cooling effort, and therefore generally to a larger required fluid flow.

The control device is preferably designed to determine the heat capacity of the containers on the basis of a container weight. The container weight can, for example, be determined by the control device on the basis of the weight of a container production batch. Furthermore, the container weight can be known, as the same type of container is usually produced with the drying apparatus. This value can be used by the control device, for example. It is preferable that the container weight is provided to the control device. Furthermore, it is preferred that the control device is designed to further determine the heat capacity taking into account the container material.

In a further preferred embodiment of the drying apparatus, it is provided that the at least one container property is an air temperature at a predefined distance from the containers. The container temperature can be determined on the basis of the air temperature. This means that the container temperature can be determined more easily and/or more cheaply. It is particularly preferred that the air temperature is determined within the cooling portion.

In a further preferred embodiment of the drying apparatus, it is provided that it comprises at least one temperature sensor coupled to the control device for detecting the container temperature and/or the air temperature. The air temperature refers in particular to the air temperature at a predefined distance from the containers. The temperature sensor can be an infrared sensor, for example.

The temperature sensor can, for example, be arranged at a container inlet and/or a container outlet of the cooling portion. It is also preferred that the drying apparatus has two or more temperature sensors within the cooling portion in order to enable redundant measurement of the temperature and also to determine a temperature gradient.

Furthermore, it may be preferred that the at least one container property is a transport density of the containers. In particular, the transport density is the number of containers per unit of time that enter and/or are moved through the cooling portion and/or exit the cooling portion.

Another preferred embodiment is characterized by the fact that the drying apparatus has a transport density sensor for detecting the transport density. The transport density sensor is preferably located inside the cooling portion. The transport density sensor can be a light barrier, for example.

It is furthermore preferred that the at least one container property is a container geometry of the containers. The container geometry can be, for example, a container height, a container diameter, and/or a container volume. Preferably, the drying apparatus comprises a geometry sensor for detecting the container geometry, with the geometry sensor preferably being arranged inside the cooling portion. The geometry sensor can, for example, be designed as one, two, or more light barriers.

In a further preferred embodiment of the drying apparatus, it is provided that the control device is designed to control the fluid flow device according to the at least one container property in such a way that a fluid quantity per unit time, a fluid velocity, and/or a fluid pressure of the fluid flow is set in order to cool the containers with the fluid flow. Furthermore, it is preferred that the fluid quantity per unit of time, the fluid velocity, and/or the fluid pressure of the fluid flow is set in such a way that the containers are cooled to or below a predefined temperature. It is also preferred that the drying apparatus has a fluid pressure sensor which is designed to determine the fluid pressure of the fluid flow.

In a further preferred embodiment, it is provided that the fluid flow device has a fluid flow element which can be rotated at a rotational velocity to generate the fluid flow and the control device is designed to control the rotational velocity of the fluid flow element according to the container property. In particular, the fluid flow element can be an impeller. The impeller can also be referred to as a fan.

By controlling the fluid flow element via the control device, the control device can directly control the fluid flow element and thus adjust the fluid flow, in particular the fluid quantity per unit of time, the fluid velocity, and/or the fluid pressure.

A further preferred embodiment of the drying apparatus is characterized in that the cooling portion comprises a fluid outlet, wherein the fluid flow element is arranged and designed to effect a defined fluid flow from the fluid outlet. The fluid flow can be defined, for example, by a fluid quantity per unit of time, a fluid velocity, and/or a fluid pressure of the fluid flow.

It is also preferred that the fluid flow element acts within the fluid outlet. Alternatively or additionally, the fluid flow element can be arranged adjacent to the fluid outlet. The fluid outlet can, for example, be designed as a channel or a tube, within which the fluid flow element is arranged. The fluid pressure sensor is preferably arranged adjacent to the fluid outlet. It is also preferred that the fluid pressure sensor is arranged inside the channel or pipe.

A further preferred embodiment of the drying apparatus is characterized in that the drying apparatus is a pin oven and/or a belt dryer, in particular for drying an internal coating of the containers, or comprises a pin oven and/or a belt dryer. The pin furnace is also known as a pin oven. In particular, the pin oven is designed to dry the paint on an outer surface of the containers, as the containers are held by a pin that protrudes into the cavity of the containers. The belt dryer is also known as an IBO, or Internal Baking Oven. Such an IBO is provided in particular for drying the paint on an inner surface of the containers. Furthermore, it is preferred that the drying apparatus is or comprises a continuous dryer for drying the containers after a cleaning process, for example with water, also known as a washer.

According to a further aspect, the task mentioned at the beginning is solved by a method for drying containers with at least one container property, comprising the steps of determining a container property of the containers, applying a fluid flow to the containers, and adjusting the fluid flow according to the container property for cooling the containers. In particular, the loading and setting steps can be carried out completely or partially in parallel.

The container property can be determined, for example by measuring. In addition or alternatively, the determination can also be a reception of data characterizing the at least one container property. It is particularly preferred that a fluid quantity per unit of time, a fluid velocity, and/or a fluid pressure of the fluid flow is set.

Furthermore, it is preferred that a rotational velocity of a fluid flow element for generating the fluid flow is controlled according to the container property.

The method and its possible embodiments have features or method steps which make them particularly suitable for use with the drying apparatus and its embodiments.

For further advantages, embodiment variants, and embodiment details of the method and its possible embodiments, reference is also made to the previous description of the corresponding features and embodiments of the drying apparatus.

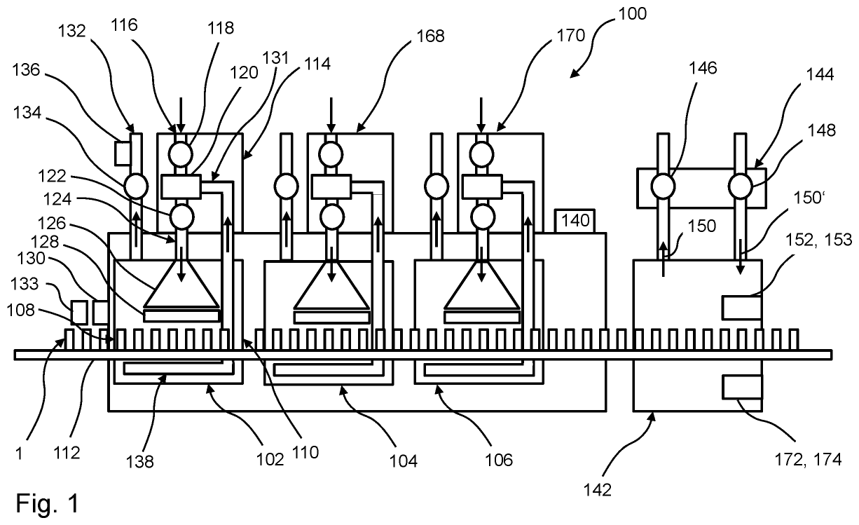

FIG. 1 shows a drying apparatus 100 with a first drying chamber 102, a second drying chamber 104, and a third drying chamber 106. Furthermore, the drying apparatus 100 comprises a cooling portion 142. A conveyor unit 112 extends through the drying chambers 102, 104, 106, and the cooling portion 142. Container 1 is moved through the drying apparatus 100 by means of the conveyor unit 112.

The drying chambers 102, 104, 106 exhibit a similar structure, so that only the drying chamber 102 is described in detail below, wherein these explanations also apply to the drying chamber 104 and the drying chamber 106 with the necessary modifications. The drying chamber 102 extends in a horizontal direction from an entry side 108, at which the container 1 enter the drying chamber 102, to an exit side 110, at which the container 1 leave the drying chamber 102 again.

Furthermore, the drying apparatus 100 has a first fluid flow device 114 that is fluidly coupled to the drying chamber 102. Further, the drying apparatus 100 has a second fluid flow device 168 fluidly coupled to the drying chamber 104 and a third fluid flow device 170 fluidly coupled to the drying chamber 106.

The first fluid flow device 114 has a fluid inlet 116 through which a process fluid, in this case air, can enter the first fluid flow device 114. In a fluid flow direction downstream of the fluid inlet 116, a supply air fan 118 is arranged to direct the air flowing into the first fluid flow device 114 to a heating device 120. Alternatively, the supply air fan 118 can also be configured as a flap. The heating device 120 can be a gas burner, for example.

Downstream of the heating device 120, a recirculated air fan 122 is arranged, which causes a fluid flow into the drying chamber 102. For this purpose, the recirculated air fan 122 is fluidically coupled to the drying chamber 102 by means of a fluid duct 124.

Within drying apparatuses, uniformity problems often occur with the air flow, wherein the aim is to direct the air as evenly as possible onto the container 1. For this purpose, the first fluid flow device 114 has a first fluid distribution unit 126, which in the present case is designed as a V-orifice. A second fluid distribution unit 128 is provided downstream, which ensures further optimized distribution of the process fluid. The second fluid distribution unit 128 is configured as a perforated plate. From there, the air reaches the container 1, which are moved under the fluid flow unit 114 by means of the conveyor unit 112.

The conveyor unit 112 is preferably configured to be permeable to air. As a result, after the air has passed through the container 1, it passes under the conveyor unit 112, where it meets a fluid collection channel 138. The fluid collection channel 138 returns the process fluid to the heating device 120 by means of a recirculated air duct 131. The use of such recirculated air reduces the energy requirement of the fluid flow device 114.

In order not to substantially exceed a maximum value of a solvent content in the drying chamber 102, a portion of the process fluid should flow out of the drying chamber 102. For this purpose, the first fluid flow device 114 has a fluid outlet 132 which is fluidically coupled to an exhaust air fan 134. Furthermore, a fluid flow measuring unit 136 is arranged at the fluid outlet 132, which is arranged and configured to measure a fluid flow flowing out of the drying chamber 102, for example in cubic meters per hour.

In addition, the drying apparatus 100 has a transport density sensor 130 for determining the container 1 entering the drying chamber 102 per time unit. Furthermore, a quality measuring unit 133 is provided, by means of which at least one container quality can be determined.

A control device 140 is designed to control the first fluid flow device 114 based on a determined solvent input. In particular, the control device 140 is designed to determine a target fluid flow to be discharged from the drying chamber 102 according to the solvent input and to control the first fluid flow device 114 in such a way that a fluid flow discharging from the drying chamber 102 at least corresponds to the target fluid flow. For example, the target fluid flow may be a minimum fluid flow selected such that a solvent content in the drying chamber 102 substantially does not exceed a predetermined value, preferably the predetermined value representing an explosion limit.

In particular, the control device 140 is designed to determine the solvent input based on a transport density, describing the container 1 entering the drying chamber 102 per time unit and/or based on a solvent quantity per container 1. The transport density can also be provided as a value of the control device 140, in particular by a device arranged upstream of the drying apparatus 100, for example a painting system.

The control device 140 is coupled in particular with the transport density sensor 130 and the quality measuring unit 133 by means of signal technology, so that the control device 140 can determine the solvent input on the basis of measured values from the transport density sensor 130 and the quality measuring unit 133. In addition, the measured value of the transport density sensor 130 and the transport density value provided as described above can also be taken into account in order to ensure a high level of safety by means of redundancy.

The drying apparatus further comprises the cooling portion 142, in which the container 1 is cooled during intended operation. Further, the drying apparatus 100 comprises a fluid flow device 144 arranged and configured to apply a fluid flow to the container 1 within the cooling portion 142. The control device 140 is arranged to control the fluid flow 150, 150′ effected by the fluid flow device 144 according to the container property.

The fluid flow device 144 includes a fluid flow element 146 disposed at a fluid outlet of the cooling portion 142. The fluid flow element 146 can be a fan, for example. In addition, the fluid flow device 144 comprises a fluid inlet flap 148 disposed at a fluid inlet of the cooling portion 142. The fluid flow 150 is the fluid flow that flows out of the cooling portion 142. The fluid flow 150′ is the fluid flow that flows into the cooling portion 142.

In addition, a velocity sensor 152 is arranged in the cooling portion 142, which is set up to detect a conveying velocity of the container 1 through the cooling portion 142. In addition, a transport density sensor 153 is arranged, which can determine a transport density of the container 1. The transport density sensor 153 can, for example, be designed as a light barrier. Furthermore, a temperature sensor 172 for detecting a temperature of the container 1 and a geometry sensor 174 for detecting a geometry of the container 1 are arranged within the cooling portion 142.

The arrangement of the sensors 152, 153, 172, 174 is schematic. The sensors may each be disposed above or below the conveyor unit 112 and may further be disposed at a container inlet and/or at a container outlet or between the container inlet and the container outlet of the cooling portion 142.

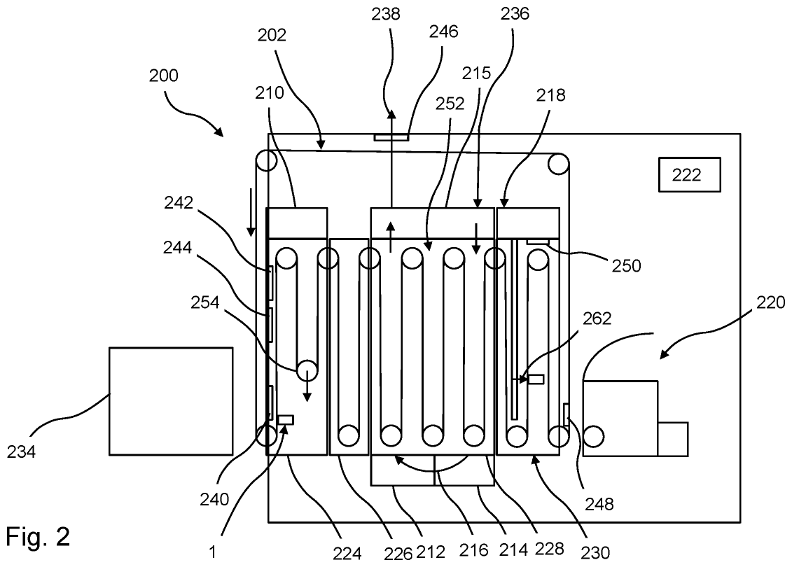

FIG. 2 shows a pin oven 200. The pin oven 200 comprises a conveyor unit 202, which is designed as a chain. The pin furnace 200 further comprises a stabilizing unit 210, a recirculated air fluid unit 212, a fluid flow unit 215, a cooling fluid unit 218, and a container removal unit 220.

The container 1 is coated in a printing device 234 not included in the pin oven 200, in particular with a lacquer containing solvents. The container 1 is transferred from the printing device 234 to the pin oven 200. The printing device 234 and the pin oven 200 can be coupled to each other in such a way that the printing device 234 drives the conveyor unit 202.

The container 1 is first placed in a pre-drying frame 224. A stabilizing unit 210 acts in the pre-drying frame 224 to stabilize the container 1 with a fluid flow at the conveyor unit 202. The stabilization unit 210 is coupled to a control device 222 and is set by the latter in such a way that the container 1 is stabilized on the transport pins 204, 204′, 204″ according to the container properties. In addition, a chain tensioner 254 is provided within the pre-drying frame 224, which tensions the chain of the conveyor unit 202 so that it always has a predefined tension.

The pin oven 200 also has a transport density sensor 240, which measures the container 1 entering the pin oven per time unit. The transport density sensor 240 may have two or more individual sensors to enable redundant measurement of the transport density. In addition, the pin-type furnace 200 has a velocity measuring unit 242 which measures the conveying velocity at which the container 1 is conveyed through the pin-type furnace 200. Furthermore, the pin oven 200 has a container measuring unit 244, which is designed to measure at least one container property.

Downstream of the pre-drying frame 224, the pin oven 200 has a bottom coater 226. Downstream of the bottom coater 226, the pin oven 200 has an oven unit 228. The oven unit 228 forms an oven chamber 252 in which the container 1 is heated to a high temperature, for example more than 180 degrees Celsius for at least 0.5 seconds. For this purpose, the oven unit 228 has a heating unit 214. The heating unit 214 can be a gas burner, for example. The heating unit 214 is coupled to a recirculated air fluid unit 212, which moves the fluid flow in the fluid flow direction 216, i.e., first from the oven chamber 252 into the heating unit 214, then into the recirculated air fluid unit 212, and then back into the oven chamber 252. In this way, a heated fluid flow is made available to the oven chamber 252.

The oven unit 228 is furthermore coupled to a fluid flow unit 215. The fluid flow unit 215 is arranged and configured to provide a fluid from the environment of the pin oven 200 to the oven unit 228, and to supply a fluid out of the oven unit 228. For this purpose, the pin-type furnace has a fluid inlet device 236 and a fluid outlet device 238. The fluid outlet device 238 is further coupled to a fluid flow sensor 246, which is designed to measure the fluid flow.

In addition, a first temperature sensor 248 and a second temperature sensor 250 are arranged in the cooling portion 230, which are designed to detect a container temperature of the container 1 within the cooling portion 230. The control device 222 is preferably designed to determine a temperature profile of the container 1. Furthermore, it may be preferable to arrange three or more temperature sensors, in particular a plurality, in order to determine a detailed temperature curve, for example.

The cooling portion 230 is designed in such a way that the container 1 can be cooled in it. Further, the pin furnace 200 comprises a fluid flow device 218 arranged and configured to apply a fluid flow 262 to the container 1 within the cooling portion 230. The control device 222 is designed to control the fluid flow 262 effected by the fluid flow device 218 according to the container property. Moreover, the cooling portion 230 can have essentially the same elements and functions as the cooling portion 142 of the drying apparatus 100 described above.

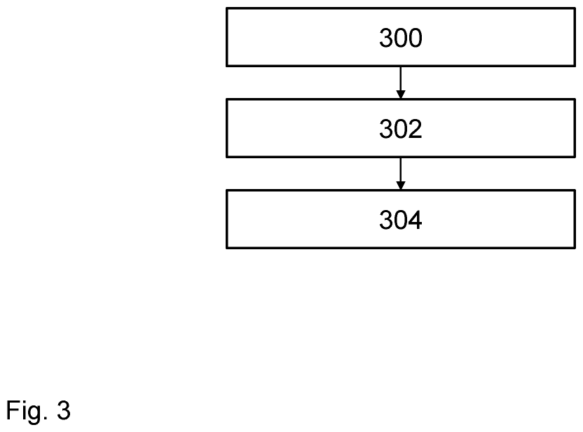

FIG. 3 shows a schematic view of a method. In step 300, a container property of the container 1 is determined. The container property can be, for example, a container temperature, a conveying velocity, a heat capacity, an air temperature at a predefined distance from the containers, a transport density, and/or a container geometry. In step 302, the container 1 is pressurized with a fluid flow. The fluid flow preferably has a defined property, in particular a fluid quantity per unit of time, a fluid velocity and/or a fluid pressure. In step 304, the fluid flow is adjusted according to the container property for cooling the container 1. In particular, the property of the fluid flow mentioned above is set. Steps 302 and 304 may run partially or completely parallel in time.

With a drying apparatus described above and the method for drying container 1 with at least one container property, an energy-efficient production of container 1, in particular of cans, is made possible. The container 1 can be produced with a lower energy input, in particular due to a high energy-saving effect in the area of the cooling portion 142, 230 of the drying apparatus 100, 200.

As a result, the energy required to produce a single can is reduced, thereby reducing the ecological footprint of each individual can. Considering that several hundred billion cans are produced worldwide every year, the present invention has a high savings effect on global energy consumption.

### REFERENCE SYMBOLS

1 Container
100 Drying apparatus
102 First drying chamber
104 Second drying chamber
106 Third drying chamber
108 Entry side
110 Exit side
112 Conveyor unit
114 First fluid flow device
116 Fluid inlet
118 Supply air fan
120 Heating device
122 Recirculated air fan
124 Fluid duct
126 First fluid distribution unit
128 Second fluid distribution unit
130 Transport density sensor
131 Recirculated air duct
132 Fluid outlet
133 Condition measuring unit
134 Exhaust air ventilator
136 Fluid flow measuring unit
138 Fluid collection channel
140 Control device
142 Cooling portion
144 Fluid flow device
146 Fluid current element
148 Fluid inlet flap
150, 150′ Fluid flow
152 Velocity sensor
153 Transport density sensor
168 Second fluid flow device
170 Third fluid flow device
172 Temperature sensor
174 Geometry sensor
200 Pin stoppers
202 Conveyor unit
210 Stabilization unit
212 Recirculated air fluid unit
214 Heating unit
215 Fluid flow unit
216 Fluid flow direction
218 Fluid flow device
220 Container removal unit
222 Control device
224 Pre-drying frame
226 Floor coater
228 Oven unit
230 Cooling portion
234 Printing device
236 Fluid inlet device
238 Fluid outlet device
240 Transport density sensor
242 Velocity measuring unit
244 Container measuring unit
246 Fluid current sensor
248 First temperature sensor
250 Second temperature sensor
252 Oven room
254 Chain tensioner
262 Fluid flow

1. A drying apparatus for drying containers having at least one container property, the apparatus comprising:
a cooling portion in which the container can be cooled;
a fluid flow device arranged and designed to apply a fluid flow to the container within the cooling portion; and
a control device designed to control the fluid flow device according to the at least one container property in such a way that the container is cooled with the fluid flow.

2. The drying apparatus according to claim 1, further comprising:
a conveyor unit with which the container can be moved through the cooling portion at a conveying velocity,
where the at least one container property is the conveying velocity.

3. The drying apparatus according to claim 1, further comprising a velocity sensor coupled to the control device by signal technology for detecting the conveying velocity.

4. The drying apparatus according to claim 1, wherein the at least one container property is a container temperature and/or a heat capacity of the container.

5. The drying apparatus according to claim 1, wherein the at least one container property is an air temperature at a predefined distance from the containers.

6. The drying apparatus according to claim 1, further comprising at least one temperature sensor coupled to the control device for detecting the container temperature and/or the air temperature.

7. The drying apparatus according to claim 1, wherein the at least one container property is a transport density of the container.

8. The drying apparatus according to claim 1, further comprising a transport density sensor for detecting the transport density.

9. The drying apparatus according to claim 1, wherein the at least one container property is a container geometry of the container.

10. The drying apparatus according to claim 1, further comprising a geometry sensor for detecting the container geometry.

11. The drying apparatus according to claim 1, wherein the control device is designed to control the fluid flow device according to the at least one container property in such a way that a fluid quantity per unit of time, a fluid velocity, and/or a fluid pressure of the fluid flow is set in order to cool the container with the fluid flow.

12. The drying apparatus according to claim 1, wherein
the fluid flow device comprises a fluid flow element rotatable at a rotational velocity for generating the fluid flow, and
the control device is designed to control the rotational velocity of the fluid flow element according to the container property.

13. The drying apparatus according to claim 1, wherein the cooling portion comprises a fluid outlet, wherein the fluid flow element is arranged and configured to effect a defined fluid flow from the fluid outlet.

14. The drying apparatus according to claim 1, wherein the drying apparatus is a pin oven and/or a belt dryer or comprises a pin oven and/or a belt dryer.

15. A method of drying containers having at least one container property, the method comprising:
determining a container property of the container;
pressurizing the container with a fluid flow; and
adjusting the fluid flow according to the container properties for cooling the container.

16. The drying apparatus of claim 8, wherein the transport density sensor is arranged within the cooling portion
